(19) United States
(12) Patent Application Publication
(10) Pub. No.: US 2026/0118514 A1
(43) Pub. Date: Apr. 30, 2026

(54) METHOD FOR PROVIDING AT LEAST ONE CORRECTION VALUE FOR AN OUTPUT DISTANCE IMAGE OF A TIME-OF-FLIGHT SENSOR, TIME-OF-FLIGHT SENSOR AND COMPUTER PROGRAM PRODUCT

(71) Applicant: SICK AG, Waldkirch (DE)

(72) Inventor: Jennifer ERDMANN, Witzhave (DE)

(21) Appl. No.: 19/265,596

(22) Filed: Jul. 10, 2025

(30) Foreign Application Priority Data
Jul. 15, 2024 (DE) 10 2024 120 052.9

(51) Int. Cl. G01S 17/894; G01S 7/481; G01S 7/4865

(52) U.S. Cl. CPC G01S 17/894; G01S 7/4816; G01S 7/4865

(57) ABSTRACT

In one embodiment, a method for providing at least one correction value for an output distance image of a time-of-flight sensor (10) comprises the following steps: supplying an individual image, wherein one, preferably each, data point (14) of the individual image comprises a distance value, a total peak height and a total peak width that were each determined from an echo signal (S′), which was received from the time-of-flight sensor (10), by at least two detector elements (14a, 14b); for a plurality of data points, preferably for each data point (14), of the individual image, determining at least two individual peak heights in dependence on the total peak height and the distance value of the respective data point and determining at least two individual peak widths in dependence on the total peak width and the distance value of the respective data point; for a plurality of data points, preferably for each data point (14), of the individual image, determining a respective distance-dependent individual distance correction value for one, preferably for each, detector element (14a, 14b) on the basis of the individual peak height or on the basis of the individual peak height and the individual peak width and providing a total distance correction value of the respective data point as a function of the individual distance correction values.

The present invention relates to a method for providing at least one correction value for an output distance image of a time-of-flight sensor, to a time-of-flight sensor and to a computer program product.

Time-of-flight sensors are used to carry out distance measurements. Depending on the design of the sensor, optical signals are, for example, used that are used in so-called LiDAR sensors (Light Detection and Ranging) for the measurement. The distance of an object in the environment of the sensor is determined by measuring the time of flight. During this measurement, a LIDAR sensor emits a transmission signal, for example a pulsed laser signal, that is reflected at the object. The reflected pulses are detected by the sensor in the form of an echo signal. Based on this echo signal, the sensor determines the time of flight of the pulses from the sensor to the object and back and calculates the distance of the object therefrom.

An accuracy of the distance values provided by a LIDAR sensor depends on different factors and effects. For example, a reflectivity of an object or a target, a noise in the environment of the sensor, also called the noise floor, and an implementation of the receiver unit of the sensor influence the measurement result, in particular its quality and accuracy. Usually, photodiodes, preferably avalanche photodiodes (APDs), particularly preferably single photon avalanche photodiodes (SPADs), are used for detecting the echo signal. Said photodiodes enable a counting of the photons arriving on their surface, in particular a single photon count. However, the use of SPADs, in which an avalanche breakdown is triggered by the impact of a single photon, causes certain dead time effects that are a consequence of the re-biasing of the SPAD after an avalanche breakdown. Furthermore, it is common to interconnect a plurality of SPADs or APDs so that the common output signal of the interconnected diodes results in a pixel or a data point of a distance image to be output by the sensor.

The influences during the time-of-flight measurement and the architecture of the receiver unit of a LiDAR sensor can lead to a distortion of the detected peak shape of a laser pulse under certain circumstances. Since the sensor performs the distance calculation on the basis of this peak shape, a so-called walk error occurs that impairs the distance accuracy of the sensor. The walk error refers to a measured systematic distance error that is caused by peak distortions.

LIDAR sensors from the prior art correct this walk error in a distance-independent manner, i.e. independently of the distance between the sensor and the target. Here, for example, look-up tables are used that, with reference to the measured peak height and peak width, correct the distance determined on the basis of said measured peak height and peak width. With this model, it is assumed that the walk error is independent of the distance from the target.

In many LiDAR sensors, the transmitter and the receiver are not arranged on the same optical axis, which leads to a certain, non-negligible parallax. Accordingly, a position of the laser spot on the receiver depends on the distance of an object. As soon as a plurality of photodiodes are connected to form a pixel, the parallax influences the walk error by causing a shift of the laser beam obtained with the echo signal, or of the pulses of the laser beam, on the diodes connected in the form of an array, for example. These diodes thereby no longer receive the same optical power. Above all, the ratio of the optical powers on the photodiodes connected to form a pixel changes in a non-negligible way with the distance of a target object. A correction of the resulting measurement error according to the distance-independent walk error correction from the prior art leads to a residual error, which can, for example, amount to up to 15 cm, at certain distances.

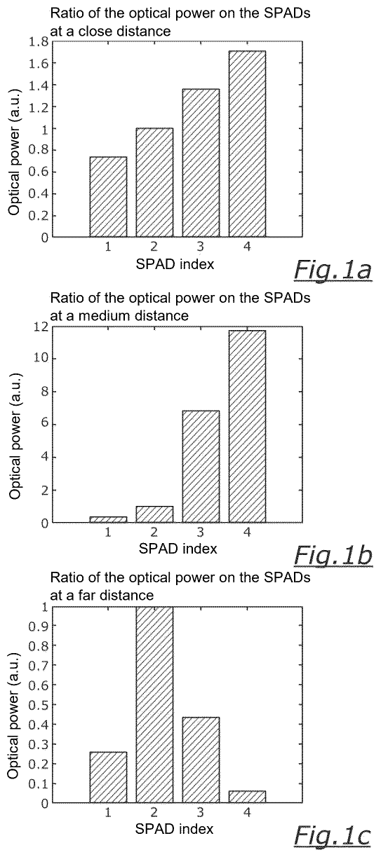

The described problem of the distance-dependent variation of the optical power on photodiodes connected to form a pixel is illustrated by means of the graphs of FIGS. 1a, 1b and 1c. In this example, four SPADs, which are labeled with the index 1, 2, 3, 4, are connected in the form of an array, i.e. arranged next to one another. For each SPAD of the array, the optical power, i.e. the optical energy that reaches the surface of the respective SPAD, is displayed in milliwatts. FIG. 1a shows the optical powers of the SPADs and their ratio at a close distance, while FIG. 1b shows the ratios at a medium distance and FIG. 1c shows the ratios at a far distance. It can clearly be seen that the optical powers on the SPADs, and in particular the ratios of the optical powers of the individual SPADs to one another, vary greatly depending on the distance. If a pixel now consists of the four SPADs shown, depending on the distance, different pulse shapes result that cannot be satisfactorily corrected or compensated for using a distance-independent look-up table. Whereas at the near distance, as can be seen from FIG. 1a, all four SPADs are irradiated to a similar degree, there are already large differences between the individual SPADs at both the medium distance and the far distance since, for example, the respective most strongly illuminated SPAD is already saturated while the least strongly illuminated SPAD is still in the linear range. If all the distances are now corrected using the same table, the residual errors described above remain.

To counter this problem, a respective correction table on the basis of calibration measurements could be used for all the distances. However, the creation of this large number of tables is time-consuming and complex.

It is therefore an object of the invention to specify a method for providing at least one correction value for an output distance image of a time-of-flight sensor, as well as a time-of-flight sensor, whereby the distance accuracy of a time-of-flight sensor is further improved. In particular, it is an object to specify a method and a time-of-flight sensor that enable a correction of a distance-dependent walk error that is, for example, produced by the parallax of the receiver of the senor when using a plurality of photodiodes for one pixel.

This object is satisfied by a method according to claim 1, by the time-of-flight sensor according to claim 13 and by the computer program product of claim 14.

In one embodiment, a method for providing at least one correction value for an output distance image of a time-of-flight sensor comprises the following steps:
supplying an individual image, wherein one, preferably each, data point of the individual image comprises a distance value, a total peak height and a total peak width that were each determined from an echo signal, which was received from the time-of-flight sensor, by at least two detector elements;
for a plurality of data points, preferably for each data point, of the individual image, determining at least two individual peak heights in dependence on the total peak height and the distance value of the respective data point and determining at least two individual peak widths in dependence on the total peak width and the distance value of the respective data point;
for a plurality of data points, preferably for each data point, of the individual image, determining a respective distance-dependent individual distance correction value for one, preferably for each, detector element on the basis of the individual peak height or on the basis of the individual peak height and the individual peak width and providing a total distance correction value of the respective data point as a function of the individual distance correction values.

The proposed method therefore determines the total distance correction value of a data point or pixel in dependence on individual distance correction values that were determined separately for preferably each detector element of a data point, for example an avalanche photodiode or a single-photon avalanche photodiode. For this purpose, the total peak height determined from the echo signal per data point is first divided with respect to the roughly determined distance value of the data point into a respective individual peak height per detector element of the data point. Analogously thereto, the total peak width available in the time-of-flight sensor is divided with respect to the distance value into a respective individual peak width per detector element of the data point. Now, an individual distance correction value is determined for each detector element on the basis of the individual peak height and individual peak width determined for this element. The total distance correction value is determined by linking the individual distance correction values. With said total distance correction value, the distance value of the individual image determined in the measurement can subsequently be corrected and the output distance image can be provided with the corrected distance value.

Since the method according to the invention preferably determines an individual distance correction value for each detector element, i.e., for example, each SPAD or APD, of a data point, the distance-dependent walk error, which is caused, for example, by the architecture of the time-of-flight sensor, in particular the arrangement of a plurality of detector elements that form a data point, in the receiver of the sensor, can be compensated. The distance accuracy of the sensor is increased.

According to a further development, the total peak width of one, preferably of each, data point is a function of at least two peak widths that were detected from the echo signal by the at least two detector elements of the time-of-flight sensor that are assigned to the respective data point. The total peak height of one, preferably of each, data point is a function of at least two peak heights that were detected from the echo signal by the at least two detector elements of the time-of-flight sensor that are assigned to the respective data point.

In the normal operation or standard operation of a time-of-flight sensor, only the total peak width and total peak height of a data point or pixel, which were each measured or determined from the echo signal, are known or accessible. The total peak height is made up of the peak heights detected by each detector element of the data point. For example, the total peak height is the sum of the peak heights of all the detector elements of the data point. Similarly, the total peak width of the data point is made up of the peak widths detected in the detector elements of this data point.

According to a further development, the determination of the at least two individual peak widths takes place in dependence on the total peak width and the distance value of the respective data point on the basis of a first table. The determination of the at least two individual peak widths takes place in dependence on the total peak width and the distance value of the respective data point on the basis of a second table. Each detector element is assigned a determined individual peak height and a determined individual peak width.

Since, as described, only the total peak height and the total peak width of a data point can be accessed in normal operation, an individual peak height and an individual peak width for the roughly measured distance value are determined for preferably each detector element of the data point using the first and the second table. In other words, the individual peak heights of the peaks of the individual photodiodes, for example SPADs, are determined on the basis of the total peak height and the rough distance of the peak. In this respect, these theoretical individual peak heights largely correspond to the peak heights that are measured by the detector elements, but that cannot be accessed individually. The second table allows a determination of the individual peak widths of the individual SPADs of a data point with respect to a respective total peak width and rough distance of the peak of the data point.

In one embodiment, the total peak height is additionally converted into a noise floor-adjusted and noise floor-normalized total peak height before determining the individual peak heights in order to eliminate the noise floor and saturation effects. For this purpose, a value for the noise floor is subtracted from the total peak height and set into relationship with a difference from a maximum peak height and the noise floor value.

According to a further development, the total distance correction value of the respective data point is provided as a mean value of the individual distance correction values. It is preferably provided as a weighted mean value of the individual distance correction values. The total distance correction value is particularly preferably provided as a mean value of the individual distance correction values that is weighted according to the individual peak heights or individual peak widths.

Advantageously, according to the invention, the architecture of the receiver of the time-of-flight sensor is considered in the determination of the total distance correction value by the different weighting of the individual distance correction values.

According to a further development, the determination of the respective distance-dependent individual distance correction value for the respective detector element of a data point takes place on the basis of the individual peak height or on the basis of the individual peak height and the individual peak width using a third table. A table known from the prior art is, for example, used as a third table that assigns a correction value to a peak height or assigns a correction value to a combination of the peak height and the peak width. If the individual peak height lies below a saturation limit, only the individual peak height is used to determine the individual distance correction value. If the individual peak height reaches or exceeds a saturation limit, the individual peak width is additionally used to determine the individual distance correction value from the third table. This is based on the experience that the optical power on the detector surface of a photodiode cannot saturate, but the counts of the photons determined by the APD or SPAD can already reach saturation.

According to a further development, exactly one individual distance correction value is determined for the at least two detector elements of a data point if the at least two individual peak heights of a data point do not differ significantly.

If the determined individual peak heights show that the detector elements that form a data point were irradiated with approximately the same optical power independently of the distance, it is thus not necessary to determine an individual distance correction value for each detector element. Computing time and computing power are thereby saved when determining the total distance correction value.

In a further embodiment, the method additionally comprises:
detecting a respective strength of the environmental noise by one,
preferably each, detector element of the respective data point, wherein the respective detected strength of the environmental noise is additionally used when determining the respective individual distance correction value.

For this purpose, the first and/or the second table is/are each extended by one dimension, namely by values for the strength of the environmental noise. The noise floor of the data point is thereby considered in the determination of the individual distance correction values. This is particularly advantageous for LiDAR sensors which are very noise-dependent, i.e. in which the dependence of the total peak height, i.e. the total intensity of a data point, and/or the total peak width in relation to the detector elements is highly noise-dependent.

In a further embodiment, the method furthermore has the following steps that are carried out in advance for a plurality of, preferably for all, the detector elements assigned to a data point and for a plurality of data points, preferably for each data point:
determining a respective individual distance correction value for a peak height and peak width determined by the detector element and
creating the third table that assigns the determined individual distance correction value to each detected combination of the peak height and the peak width.

The steps of this embodiment are carried out in advance to calibrate the time-of-flight sensor, i.e. before the normal operation of the sensor starts, in which the method according to the invention for providing the correction value is carried out. For this purpose, the time-of-flight sensor is configured so that each detector element individually outputs a peak height and a peak width from the received echo signal. An object is now positioned at a specific, known distance from the time-of-flight sensor. The individual distance correction value is determined from the comparison of the known distance with the distance determined by the detector element on the basis of the peak height and peak width. In this way, a detector element-related walk error calibration is measured and calibrated for the determined distance. In other words, different targets are measured at different distances. A respective difference to the ground truth distance is recorded in the third table in dependence on the peak height and/or peak width as an individual distance correction value.

The distance dependence of the total distance correction value is therefore inter alia achieved in that the arrangement of the detector elements, in particular the parallax of the receiver of the time-of-flight sensor, is considered in the determination of the individual peak heights and individual peak widths on the basis of the total peak height and the roughly measured distance.

In a further embodiment, the method furthermore has the following steps that are carried out in advance for a plurality of, preferably for all, the detector elements assigned to a data point:
determining a respective distance-dependent factor that corresponds to a dependence of the determined peak height on the optical power with respect to a position of the respective detector element in relation to the position of at least a second detector element of the same data point,
determining a distance-independent function of the determined peak height, said distance-independent function being dependent on the optical power,
determining a distance-dependent function of the determined peak height, said distance-dependent function being dependent on the optical power, by multiplying the respective determined distance-independent function by the distance-dependent factor,
   wherein the method furthermore comprises the following steps that are performed in advance for a plurality of data points, preferably for each data point:
determining a distance-dependent function of the total peak height of the respective data point, said distance-dependent function being dependent on the optical power, on the basis of the distance-dependent functions of the peak heights, said distance-dependent functions being dependent on the optical power of the detector elements assigned to the respective data point, in particular by summing up said peak heights, and
creating the first table on the basis of the determined distance-dependent function of the total peak height of the respective data point, said determined distance-dependent function being dependent on the optical power, and on the basis of the respective distance-dependent function of the peak height, said respective distance-dependent function being dependent on the optical power of each detector element assigned to the data point, wherein the first table assigns respective individual peak heights of the detector elements assigned to the data point to a respective detected combination of the total peak height and the distance value of the respective data point.

To measure the distance-dependent ratio of the optical power on the individual detector elements of a data point, the time-of-flight sensor is also configured in this embodiment so that the output of a detector element, i.e. the peak height and the peak width, can be tapped. To determine the distance-dependent factor, an object or target is shifted in the distance relative to the time-of-flight sensor. At each distance, the ratio of the peak height determined by a detector element as a function of the optical power with respect to the position of the detector element is determined in comparison to the remaining detector elements with which said detector element is combined to form a data point in subsequent normal operation. So that none of the detector elements become saturated, a weakly reflective target is preferably used. In addition, a neutral density filter (ND filter) can also be used to prevent saturation effects and thus a distortion of the ratios. For clarification, FIGS. 1a, 1b, and 1c each show, by way of example, a diagram of the ratio of the optical power on the detector elements at a certain distance. In this example, four detector elements, here SPADs, are combined into one data point. The detector elements are labeled with the indices 1 to 4. FIG. 1a shows the ratio of the optical powers at a close distance, whereas FIG. 1b shows them at a medium distance, and FIG. 1c at a far distance. It can be seen that, at a medium distance, the most strongly illuminated detector element 4 is already saturated while the weakest SPAD 1 is still in the linear range. At each distance, different ratios of the optical powers on the individual detector elements result and are reflected in the different peak shapes shown. The distance-dependent factors are determined from these measurements in each case.

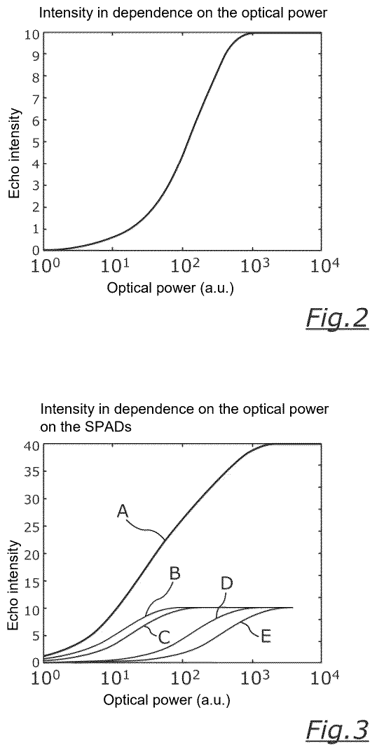

To determine the distance-independent function of the determined peak height, said distance-independent function being dependent on the optical power, the time-of-flight sensor is still left in the individual SPAD configuration. A target is positioned at a constant distance and is measured multiple times, wherein the optical power on the detector elements is in each case varied using ND filters, for example. To achieve the variation in the optical power on the SPADs, a highly reflective target can be used in conjunction with different calibrated ND filter disks or different weaker targets with suitable reflectivities are used at the same distance. Thus, the function, shown in FIG. 2, of the peak height, here referred to as echo intensity, of the relative optical power results.

To determine the distance-dependent function of the determined peak height, said distance-dependent function being dependent on the optical power, the distance-independent function described and shown by way of example in FIG. 2 is multiplied by the distance-dependent factor of the detector element in each case. The distance-dependent functions shown by way of example in FIG. 3 thereby result for a data point that is here formed from four detector elements, for example. The curve labeled A corresponds to the total peak height as a function of the optical power and is here the sum of the peak heights of the four detector elements labeled B, C, D and E. In this respect, curve B was created for the first detector element by multiplying the distance-independent function of the peak height, said distance-independent function being dependent on the optical power, for example from FIG. 2, by the distance-dependent factor determined for this detector element, which is, for example, 12, here. Curve C was created for the second detector element of the data point in a similar way, wherein the distance-dependent factor 7 was used here. Curve D corresponds to a multiplication of the curve from FIG. 2 by the distance-dependent factor 1. The distance-dependent factor 0.36 was determined and used for curve E.

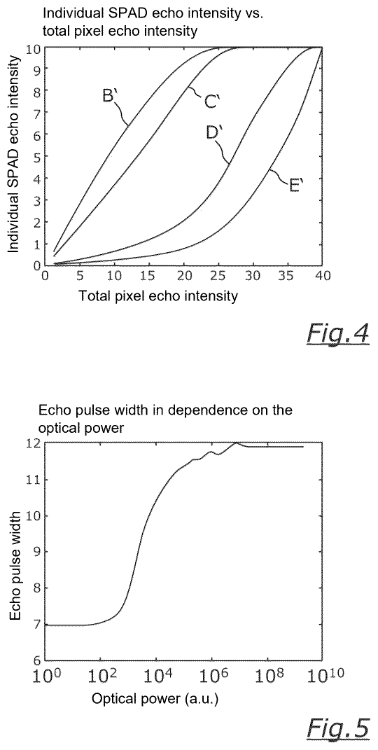

Now, the first table is created on the basis of the distance-dependent functions obtained as described above. In a further step, a list of the peak heights B, C, D and E of the respective detector elements with respect to the total peak height A is created. This is shown by way of example in FIG. 4. The total peak height is plotted on the X-axis here, while the Y-axis shows the peak heights of the individual detector elements. The curves thus obtained with respect to the total peak height are labeled B′, C′, D′ and E′. The first table according to the invention is created on the basis of the functions shown in FIG. 3 and FIG. 4. An example of the first table has the following structure:

First table

| | | Total peak height | | | |
|---|---|---|---|---|---|
| Distance | | 10 | 20 | 30 | 40 |
| 0 | m | [2.5, 2.5, 2.5, 2.5] | [5, 5, 5, 5] | [7.5, 7.5, 7.5, 7.5] | [10, 10, 10, 10] |
| 10 | m | [1, 2, 5, 2] | [3, 4, 9, 4] | [5, 7.5, 10, 7.5] | [10, 10, 10, 10] |
| 20 | m | [1, 2, 3, 4] | [3, 4, 6, 7] | [6, 7, 8, 9] | [10, 10, 10, 10] |
| 30 | m | [1, 2, 3.5, 3.5] | [3, 5, 6, 6] | [4.5, 7.5, 9, 9] | [10, 10, 10, 10] |
| 40 | m | [1.5, 3.5, 3.5, 1.5] | [4, 6, 6, 4] | [7, 8, 8, 7] | [10, 10, 10, 10] |
| 50 | m | [1, 4, 4, 1] | [3, 7, 7, 3] | [6, 9, 9, 6] | [10, 10, 10, 10] |

This is a 2D look-up table that shows the individual peak heights of the individual SPADs for a total peak height and a distance of a pixel peak in each case.

According to a further development, a two-dimensional interpolation is carried out between the individual values of the table, whereby the accuracy is increased even further.

The steps described are preferably repeated for many distances in order to calibrate table entries for each of these distances.

In a further embodiment, the method has the following steps that are carried out in advance for a plurality of, preferably for all, the detector elements assigned to a data point:
determining a respective distance-dependent factor that corresponds to a dependence of the determined peak width on the optical power with respect to a position of the respective detector element in relation to the position of at least a second detector element of the same data point,
determining a distance-independent function of the determined peak width, said distance-independent function being dependent on the optical power,
determining a distance-dependent function of the determined peak width, said distance-dependent function being dependent on the optical power, by multiplying the respective determined distance-independent function by the distance-dependent factor,
   wherein the method in this embodiment furthermore comprises the following steps that are performed in advance for a plurality of data points, preferably for each data point:
determining a distance-dependent function of the total peak width of the respective data point, said distance-dependent function being dependent on the optical power, in dependence on the distance-dependent function of the peak width, said distance-dependent function being dependent on the optical power of a plurality of, preferably all, the detector elements assigned to the respective data point, and
creating the second table on the basis of the determined distance-dependent function of the total peak width of the respective data point, said determined distance-dependent function being dependent on the optical power, and on the basis of the respective distance-dependent function of the peak width, said respective distance-dependent function being dependent on the optical power of a plurality of, preferably all, the detector elements assigned to the data point, wherein the second table assigns respective individual peak widths of the detector elements assigned to the data point to each detected combination of the total peak width and the distance value of the respective data point.

Analogously to the steps described above for creating the first table, which in each case assigns a plurality of distance-dependent individual peak heights to a total peak height, the second table is created in a calibration phase before the execution of the normal operation of the time-of-flight sensor. After the determination of a respective distance-dependent factor for a detector element, the distance-independent function of the peak width, said distance-independent function being dependent on the optical power, is determined. For this purpose, a target is measured multiple times at a constant distance from the time-of-flight sensor, wherein the optical power is varied between the measurements, for example by using suitable calibrated ND filters or by varying the reflectivity of the target. Thus, a curve is obtained, as shown in FIG. 5, that reflects the relative amplification or attenuation of the optical power on a detector element. Therefore, the measured peak widths of a detector element are plotted against the relative optical power here.

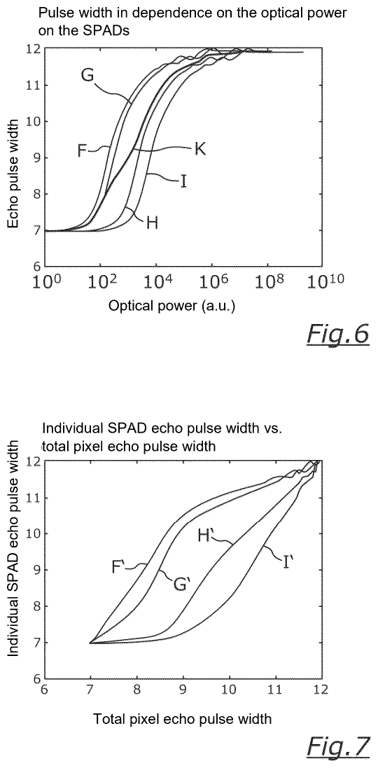

Analogously to FIG. 3, the curves of FIG. 6 are obtained by multiplying the curve from FIG. 5 by the respective distance-dependent factors of the detector elements. FIG. 6 shows, by way of example, distance-dependent functions F, G, H, I of the respective peak width of four detector elements, which are combined into one data point in a subsequent normal operation, in relation to the optical power.

In the next step, the distance-dependent function of the total peak width of the data point, said distance-dependent function being dependent on the optical power, is determined. It is shown in FIG. 6 as curve K. It results in dependence on the distance-dependent functions F, G, H, I of the respective peak widths, said distance-dependent functions being dependent on the optical power of the detector elements that are assigned to the data point. The total pulse width K depends on the specific architecture of the data point, i.e. on how the individual detector elements are arranged. In the present example, the peak widths of the detector elements are combined additively, whereby the total pulse width K of the data point results from the averaged pulse widths that are each weighted with the assigned peak heights.

The second table is created on the basis of these functions.

In a further step, the functions of the peak widths F, G, H, I from FIG. 6 are set into relationship with the total peak width K. This is shown in FIG. 7. The distance-dependent functions of the peak widths of the four detector elements that are related to the total peak width of the data point result in the form of the curves F′, G′, H′ and I′.

An exemplary second table derived from FIG. 6 or FIG. 7 has the following structure:

Second table

| | | Total peak width | | | |
|---|---|---|---|---|---|
| Distance | | 7 | 8 | 10 | 12 |
| 0 | m | [7, 7, 7, 7] | [8, 8, 8, 8] | [10, 10, 10, 10] | [12, 12, 12, 12] |
| 10 | m | [7, 7, 7, 7] | [7, 7.5, 10, 7.5] | [8, 9, 12, 9] | [12, 12, 12, 12] |
| 20 | m | [7, 7, 7, 7] | [7, 8, 9, 10] | [8, 9, 10.5, 12] | [12, 12, 12, 12] |
| 30 | m | [7, 7, 7, 7] | [7, 8, 8.5.8.5] | [8.5, 9, 11, 11] | [12, 12, 12, 12] |
| 40 | m | [7, 7, 7, 7] | [7.5, 8.5, 8.5, 7.5] | [9.5, 10.5, 10.5, 9.5] | [12, 12, 12, 12] |
| 50 | m | [7, 7, 7, 7] | [7, 8.5, 8.5, 7] | [9, 11, 11, 9] | [12, 12, 12, 12] |

This is again a 2D look-up table that assigns the individual peak widths of the individual SPADs to a total peak width and to a distance of a data point peak. According to a further development, a two-dimensional interpolation is carried out between the individual values in the table, whereby the distance accuracy is improved even further.

The steps listed above are repeated for a plurality of distances so that, for each of the calibrated distances, there is a line in the look-up table for the subsequent normal operation of the time-of-flight sensor.

In a further embodiment, the creation of the first and/or second table in each case takes place additionally considering a total noise value further included by a respective data point.

In this further development, instead of the first and second table shown above, which are each designed in 2D and which each assign the respective individual intensities, i.e. individual peak widths, of the detector elements to a rough distance and a total intensity, i.e. a total peak height, of a data point, or, on the basis of the rough distance, assigns individual peak widths of the detector elements to a total pulse width of a data point, a third table is used in each case. The total noise value of the data point, which is a measure of the noise floor, is used as the third dimension here. This is particularly advantageous if the receiver of the time-of-flight sensor is highly noise-dependent, in particular if the dependence, shown in the first and second table, of the total peak width or total peak height on the peak widths or peak heights of the individual detector elements is also highly noise-dependent. Otherwise, it is assumed that detector elements of a data point are subject to the same noise when they measure the same target so that the third dimension is not normally required for the first and second table.

In a further development, the determination of the respective distance-dependent individual distance correction values for the detector elements of a respective data point and the provision of the total distance correction value for the respective data point take place using a fourth table.

For example, the fourth table is created on the basis of the third table, which is extended by one dimension for this further development, namely by the distance originally determined for the data point. The calculation of the total distance correction value can take place in advance in the calibration phase in accordance with the procedure described above. Here, too, the calibration can be carried out with a reasonable time effort using simple measurements and automated calculations. It is not necessary to measure a table for the walk error correction for each distance individually and to calibrate a corresponding look-up table. Furthermore, this further development requires particularly little computing effort during the runtime.

A further object of the invention is a time-of-flight sensor that, according to one embodiment, has a transmission unit, a reception unit and an evaluation unit that are connected to one another. The transmission unit comprises a light source, in particular a laser diode, and is configured to transmit a transmission signal, in particular a light beam in pulsed form. The reception unit comprises a plurality of light-sensitive detector elements that each comprise a photodiode, in particular an avalanche photodiode or a single-photon avalanche photodiode. The detector elements are each configured to receive an echo signal reflected from a scene. The evaluation unit is configured to generate at least one individual image of a scene, wherein a data point of the individual image comprises a distance value, a total peak height and a total peak width that are each determined by at least two detector elements assigned to the data point. The evaluation unit is furthermore configured, for a plurality of data points, preferably for each data point, of the individual image, to determine at least two individual peak heights in dependence on the total peak height and the distance value of the respective data point and to determine at least two individual peak widths in dependence on the total peak width and the distance value of the respective data point. Furthermore, the evaluation unit is configured, for a plurality of data points, preferably for each data point, of the individual image, to determine a distance-dependent individual distance correction value for one, preferably for each, detector element on the basis of the individual peak height or on the basis of the individual peak height and the individual peak width and to provide a total distance correction value as a function of the individual distance correction values for the respective data point. For a plurality of, preferably for all, the data points of an individual image, the time-of-flight sensor according to the invention determines a correction value for the originally measured distance considering the architecture of the reception unit, in which a respective at least two detector elements, in particular their output signals, are combined into one data point. A systematic measurement error caused by this architecture, in particular a parallax, that is also referred to as a walk error and that is furthermore distance-dependent is compensated or corrected with the total distance correction value by determining an individual distance correction value for each detector element on the basis of the individual peak height and individual peak width. The distance accuracy of the time-of-flight sensor is thereby improved.

The time-of-flight sensor can also be designed as a LIDAR sensor. The advantages of the described invention become particularly clear in the case of LIDAR sensors in which a pixel or a data point is composed of a plurality of SPADs or APDs and which consequently exhibit a strong parallax, i.e. if, for example, a shift of more than half the size of the detector element occurs in the received echo signal.

Moreover, the above statements on the method according to the invention for providing at least one correction value for an output distance image apply accordingly to the time-of-flight sensor, in particular with respect to advantages and embodiments.

In one possible implementation, the time-of-flight sensor according to the invention is configured to carry out the method described above.

A further object of the invention is a computer program product that comprises a computer-readable storage medium on which a program is stored that enables a computer, after a reading of the program into a memory of the computer, to carry out the method described above for providing at least one correction value for an output distance image of a time-of-flight sensor. This is in particular important in cooperation with the time-of-flight sensor described above.

The embodiments that are described here in each case can be combined with one another, unless explicitly stated or described otherwise.

The invention will be explained in the following purely by way of example with reference to the Figures. There are shown:

FIGS. 1a to 1c in each case a diagram of the ratio of the optical power on the detector elements at a specific distance;

FIG. 2 an exemplary diagram of the peak height of a detector element with respect to the relative optical power;

FIG. 3 an exemplary diagram of the peak height of the individual detector elements in comparison with the total peak height of a data point;

FIG. 4 an exemplary diagram of the peak heights from FIG. 3 normalized to the total peak height;

FIG. 5 an exemplary diagram of the peak width of a detector element with respect to the relative optical power;

FIG. 6 an exemplary diagram of the peak widths of the detector elements of a data point in comparison with the total peak width of the data point;

FIG. 7 an exemplary diagram of the peak widths from FIG. 6 normalized to the total peak width; and

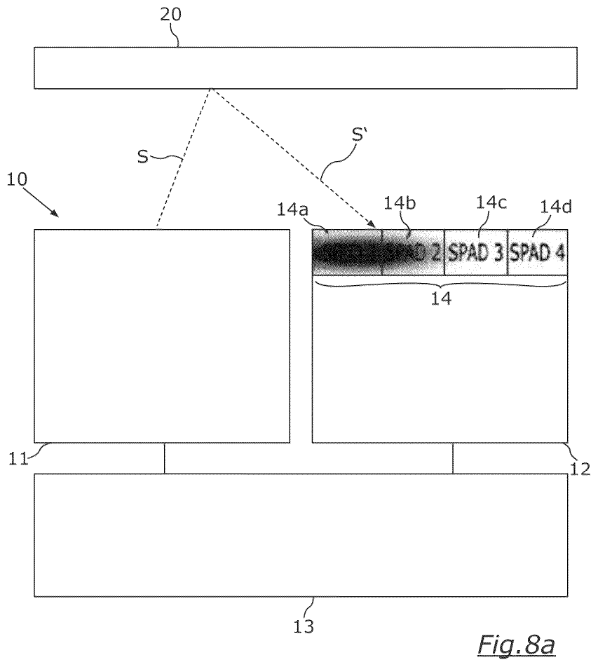

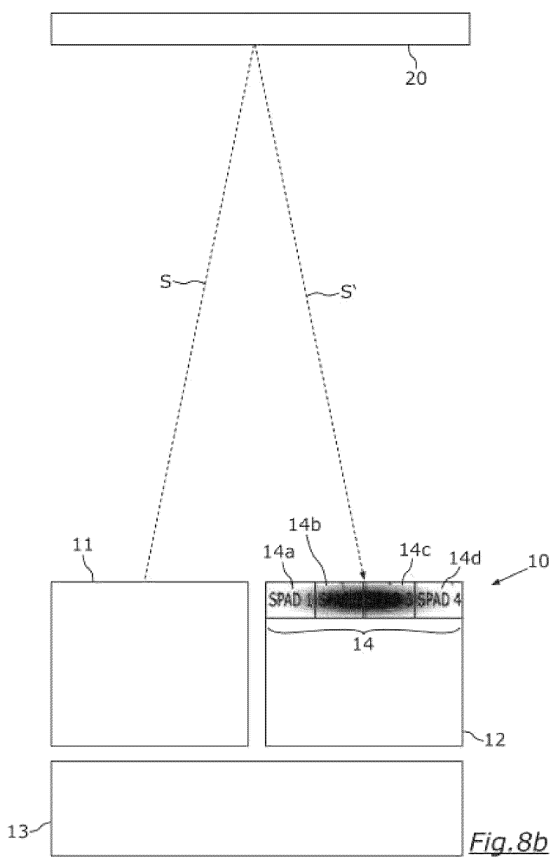

FIGS. 8a and 8b in each case an exemplary embodiment of the time-of-flight sensor as proposed.

As regards FIGS. 1 to 7, reference is made to the description further above.

FIG. 8a shows a first exemplary embodiment of the time-of-flight sensor 10 according to the invention. It comprises the transmission unit 11, the reception unit 12 and the evaluation unit 13. In the reception unit 12, a data point or a pixel 14 is shown by way of example and is formed from four detector elements 14a, 14b, 14c and 14d in this example. The output signals provided by the detector elements 14a to 14d are therefore combined into the data point 14. A distance image generated by the time-of-flight sensor consists of a large number of such data points 14. In other embodiments of the time-of-flight sensor, each data point 14 can also comprise more or fewer than the four detector elements specified in this example.

In FIG. 8a, the target or object 20 is at a short distance from the time-of-flight sensor so that, as indicated in the Figure, the echo signal S′ mainly impacts the detector elements 14a and 14b due to the parallax. Greater peak heights are thereby detected in these detector elements, for example.

Compared to FIG. 8a, the target 20 in FIG. 8b is further away from the time-of-flight sensor 10. Consequently, the echo signal S′ is received by the detector elements 14b and 14c with high intensity, whereas the detector elements 14a and 14d detect lower peak heights.

The effect of the parallax that is illustrated here and that leads to a distance-dependent walk error is advantageously compensated by the method described above and the time-of-flight sensor according to the invention.

### REFERENCE NUMERAL LIST

10 time-of-flight sensor
11 transmission unit
12 reception unit
13 evaluation unit
14 data point
14a, 14b, 14c, 14d detector element
20 object
S transmission signal
S′ echo signal
A, B, C, D, E function
A, B, C, D, E function
F, G, H, I, K function
F′, G′, H′, I′ function

1. A method for providing at least one correction value for an output distance image of a time-of-flight sensor, comprising the following steps:
supplying an individual image, wherein one data point of the individual image comprises a distance value, a total peak height and a total peak width that were each determined from an echo signal, which was received from the time-of-flight sensor, by at least two detector elements;
for a plurality of data points of the individual image, determining at least two individual peak heights in dependence on the total peak height and the distance value of the respective data point and determining at least two individual peak widths in dependence on the total peak width and the distance value of the respective data point;
for a plurality of data points of the individual image, determining a respective distance-dependent individual distance correction value for one detector element on the basis of the individual peak height or on the basis of the individual peak height and the individual peak width and providing a total distance correction value of the respective data point as a function of the individual distance correction values.

2. The method according to claim 1,
wherein each data point of the individual image comprises a distance value.

3. The method according to claim 1,
wherein at least two individual peak heights are determined in dependence on the total peak height and the distance value of the respective data point for each data point of the individual image.

4. The method according to claim 1,
wherein a respective distance-dependent individual distance correction value is determined for each data point of the individual image.

5. The method according to claim 1,
wherein the total peak width of one data point is a function of at least two peak widths that were detected from the echo signal by the at least two detector elements of the time-of-flight sensor that are assigned to the respective data point, and
wherein the total peak height of one data point is a function of at least two peak heights that were detected from the echo signal by the at least two detector elements of the time-of-flight sensor that are assigned to the respective data point.

6. The method according to claim 1,
wherein the determination of the at least two individual peak heights takes place in dependence on the total peak height and the distance value of the respective data point on the basis of a first table, and
wherein the determination of the at least two individual peak widths takes place in dependence on the total peak width and the distance value of the respective data point on the basis of a second table, and
wherein each detector element of the respective data point is assigned a determined individual peak height and a determined individual peak width.

7. The method according to claim 1,
wherein the total distance correction value of the respective data point is provided as a mean value of the individual distance correction values.

8. The method according to claim 1,
wherein the total distance correction value of the respective data point is provided as a weighted mean value of the individual distance correction values.

9. The method according to claim 1,
wherein the total distance correction value of the respective data point is provided as a mean value of the individual distance correction values that is weighted according to the individual peak heights or individual peak widths.

10. The method according to claim 1,
wherein the determination of the respective distance-dependent individual distance correction value for the respective detector element takes place on the basis of the individual peak height or on the basis of the individual peak height and the individual peak width using a third table.

11. The method according to claim 1,
wherein exactly one individual distance correction value is determined for the at least two detector elements if the at least two determined individual peak heights of a data point do not differ significantly.

12. The method according to claim 1,
further comprising
detecting a respective strength of the environmental noise by one detector element of the respective data point,
wherein the respective detected strength of the environmental noise is additionally used when determining the respective individual distance correction value.

13. The method according to claim 1,
further comprising the following steps that are carried out in advance for a plurality of the detector elements assigned to a data point and for a plurality of data points:
determining a respective individual distance correction value for a peak height and peak width determined by the detector element and creating the third table that assigns the determined individual distance correction value to a respective detected combination of the peak height and the peak width.

14. The method according to claim 1,
further comprising the following steps that are carried out in advance for a plurality of the detector elements assigned to a data point:
determining a respective distance-dependent factor that corresponds to a dependence of the determined peak height on the optical power with respect to a position of the respective detector element in relation to the position of at least a second detector element of the same data point,
determining a distance-independent function of the determined peak height, said distance-independent function being dependent on the optical power,
determining a distance-dependent function of the determined peak height, said distance-dependent function being dependent on the optical power, by multiplying the respective determined distance-independent function by the distance-dependent factor,
and further comprising the following steps that are performed in advance for a plurality of data points:
determining a distance-dependent function of the total peak height of the respective data point, said distance-dependent function being dependent on the optical power, on the basis of the distance-dependent functions of the peak heights, said distance-dependent functions being dependent on the optical power of the detector elements assigned to the respective data point, and
creating the first table on the basis of the determined distance-dependent function of the total peak height of the respective data point, said
determined distance-dependent function being dependent on the optical power, and on the basis of the respective distance-dependent function of the peak height, said respective distance-dependent function being dependent on the optical power of each detector element assigned to the data point, wherein the first table assigns respective individual peak heights of the detector elements assigned to the data point to a respective detected combination of the total peak height and the distance value of the respective data point.

15. The method according to claim 14,
wherein said distance-dependent functions are dependent on the optical power of the detector elements assigned to the respective data point by summing up said peak heights.

16. The method according to claim 1,
further comprising the following steps that are carried out in advance for a plurality of the detector elements assigned to a data point:
determining a respective distance-dependent factor that corresponds to a dependence of the determined peak width on the optical power with respect to a position of the respective detector element in relation to the position of at least a second detector element of the same data point,
determining a distance-independent function of the determined peak width, said distance-independent function being dependent on the optical power,
determining a distance-dependent function of the determined peak width, said distance-dependent function being dependent on the optical power, by multiplying the respective determined distance-independent function by the distance-dependent factor,
and further comprising the following steps that are performed in advance for a plurality of data points:
determining a distance-dependent function of the total peak width of the respective data point, said distance-dependent function being dependent on the optical power, in dependence on the distance-dependent function of the peak width, said distance-dependent function being dependent on the optical power of a plurality of the detector elements assigned to the respective data point, and
creating the second table on the basis of the determined distance-dependent function of the total peak width of the respective data point, said determined distance-dependent function being dependent on the optical power, and on the basis of the respective distance-dependent function of the peak width, said respective distance-dependent function being dependent on the optical power of a plurality of the detector elements assigned to the respective data point, wherein the second table assigns respective individual peak widths of the detector elements assigned to the data point to a respective detected combination of the total peak width and the distance value of the respective data point.

17. The method according to claim 14,
wherein the creation of the first and/or second table in each case takes place additionally considering a total noise value further included by a respective data point.

18. The method according to claim 16,
wherein the creation of the first and/or second table in each case takes place additionally considering a total noise value further included by a respective data point.

19. The method according to claim 1,
wherein the determination of the respective distance-dependent individual distance correction values for the detector elements of a respective data point and the provision of the total distance correction value for the respective data point take place using a fourth table.

20. A time-of-flight sensor comprising
a transmission unit, a reception unit and an evaluation unit that are connected to one another,
wherein the transmission unit comprises a light source and is configured to transmit a transmission signal,
wherein the reception unit comprises a plurality of light-sensitive detector elements that each comprise a photodiode, and that are each configured to receive an echo signal reflected from a scene, and
wherein the evaluation unit is configured
to generate at least one individual image of a scene, wherein a data point of the individual image comprises a respective distance value determined by at least two detector elements assigned to the data point, a total peak height and a total peak width,
for a plurality of data points of the individual image, to determine at least two individual peak heights in dependence on the total peak height and the distance value of the respective data point and to determine at least two individual peak widths in dependence on the total peak width and the distance value of the respective data point,
for a plurality of data points to determine a respective individual distance correction value for one detector element on the basis of the individual peak height or on the basis of the individual peak height and the individual peak width and to provide a total distance correction value for the respective data point as a function of the individual distance correction values.

21. The time-of-flight sensor according to claim 20,
wherein the light source is configured to transmit a light beam in pulsed form.

22. A computer program product that comprises a computer-readable storage medium on which a program is stored that enables a computer, after a reading of the program into a memory of the computer, to carry out the method for providing at least one correction value for an output distance image of a time-of-flight sensor, comprising the following steps:
supplying an individual image, wherein one data point of the individual image comprises a distance value, a total peak height and a total peak width that were each determined from an echo signal, which was received from the time-of-flight sensor, by at least two detector elements;
for a plurality of data points of the individual image, determining at least two individual peak heights in dependence on the total peak height and the distance value of the respective data point and determining at least two individual peak widths in dependence on the total peak width and the distance value of the respective data point;
for a plurality of data points of the individual image, determining a respective distance-dependent individual distance correction value for one detector element on the basis of the individual peak height or on the basis of the individual peak height and the individual peak width and providing a total distance correction value of the respective data point as a function of the individual distance correction values.

23. The computer program product according to claim 22,
wherein said method is carried out in cooperation with a time-of-flight sensor comprising
a transmission unit, a reception unit and an evaluation unit that are connected to one another,
wherein the transmission unit comprises a light source and is configured to transmit a transmission signal,
wherein the reception unit comprises a plurality of light-sensitive detector elements that each comprise a photodiode, and that are each configured to receive an echo signal reflected from a scene, and
wherein the evaluation unit is configured
to generate said at least one individual image of a scene.
